(19) United States
(12) Patent Application Publication
(10) Pub. No.: US 2013/0185205 A1
(43) Pub. Date: Jul. 18, 2013

(54) SECURE TRANSACTION AUTHORIZATION

(71) Applicants: Gregory J. Boss, Saginaw, MI (US); Rick A. Hamilton, II, Charlottesville, VA (US); Brian M. O'Connell, RTP, NC (US); James W. Seaman, Falls Church, VA (US)

(72) Inventors: Gregory J. Boss, Saginaw, MI (US); Rick A. Hamilton, II, Charlottesville, VA (US); Brian M. O'Connell, RTP, NC (US); James W. Seaman, Falls Church, VA (US)

(73) Assignee: International Business Machines Corporation, Armonk, NY (US)

(21) Appl. No.: 13/348,695

(22) Filed: Jan. 12, 2012

(51) Int. Cl. G06Q 40/00

(52) U.S. Cl. 705/44

(57) ABSTRACT

Provided is an approach for credit transaction authorization/approval. Specifically, a particular transaction payment device/mechanism (e.g., credit card, etc.) may be associated with a set of purchase authorization criteria/rules that sets forth specific conditions (e.g., an authorization protocol) under which the transaction payment device may be utilized. When a user later attempts to conduct a proposed credit transaction using the transaction payment device, it will be determined whether the proposed credit transaction complies with this set of purchase authorization criteria (e.g., the authorization protocol). Based on this determination, the proposed credit transaction can be approved or declined.

### TECHNICAL FIELD

Embodiments of the present invention generally relate to secure credit transaction authorization. Specifically, embodiments of the present invention relate to the authorization of credit transactions based upon associations of purchasing plans with credit payment devices (e.g., credit cards, radio-frequency identification (RFID) payment devices, etc.).

### BACKGROUND OF THE INVENTION

Credit card users may have one or more credit cards with which they can purchase goods and services worldwide. In most cases, such goods and services can be purchased simply by having physical possession of the card. Some cards provide limited protection by use of PIN or card code verification (CCV) numbers. However, most cards have the CCV printed on the back of the card, such that a lost or stolen card can immediately be fraudulently used by a third party having physical possession. Such fraudulent use may be exacerbated by the fact that a large number of products and services may be available for purchase on line, and, as such, the complete credit line available can be exhausted even before the card owner discovers that it has been lost or stolen.

### SUMMARY

In general, embodiments of the present invention provide an approach for secure credit transaction authorization/approval. Specifically, in a typical embodiment, a particular transaction payment device/mechanism (e.g., credit card, etc.) may be associated with a set of purchase authorization criteria/rules that sets forth specific conditions under which the transaction payment device may be utilized. Along these lines, the set of purchase authorization criteria typically comprises an authorization protocol that may be generated in multiple ways. For example, the authorization protocol may be generated: manually based on a set of predetermined authorized expenses; automatically based on at least one of the following: a set of calendar entries, a set of geographic location-based services, or a social networking check-in service; and/or automatically based upon historical purchase data stored in at least one computer storage device. When a user later attempts to conduct a proposed credit transaction using the transaction payment device, it will be determined whether the proposed credit transaction complies with this set of purchase authorization criteria (e.g., the authorization protocol). Based on this determination, the proposed credit transaction can be authorized or declined.

A first aspect of the present invention provides a computer-implemented method for authorizing credit transactions, comprising: receiving a selection of a credit payment device in a computer memory medium; receiving a set of purchase authorization criteria for the credit payment device, the purchase authorization criteria setting forth conditions for authorizing credit transactions made using the credit payment device; associating the set of purchase authorization criteria with the credit payment device; receiving a request for authorization of a proposed credit transaction made using the credit payment device; and determining whether the proposed credit transaction complies with the set of purchase authorization criteria.

A second aspect of the present invention provides a system for authorizing credit transactions, comprising: a memory medium comprising instructions; a bus coupled to the memory medium; and a processor coupled to the bus that when executing the instructions causes the system to: receive a selection of a credit payment device in a computer memory medium; receive a set of purchase authorization criteria for the credit payment device, the purchase authorization criteria setting forth conditions for authorizing credit transactions made using the credit payment device; associate the set of purchase authorization criteria with the credit payment device; receive a request for authorization of a proposed credit transaction made using the credit payment device; and determine whether the proposed credit transaction complies with the set of purchase authorization criteria.

A third aspect of the present invention provides a computer program product for authorizing credit transactions, the computer program product comprising a computer readable storage media, and program instructions stored on the computer readable storage media, to: receive a selection of a credit payment device in a computer memory medium; receive a set of purchase authorization criteria for the credit payment device, the purchase authorization criteria setting forth conditions for authorizing credit transactions made using the credit payment device; associate the set of purchase authorization criteria with the credit payment device; receive a request for authorization of a proposed credit transaction made using the credit payment device; and determine whether the proposed credit transaction complies with the set of purchase authorization criteria.

A fourth aspect of the present invention provides a method for deploying a system for authorizing credit transactions, comprising: providing a computer infrastructure being operable to; receive a selection of a credit payment device in a computer memory medium; receive a set of purchase authorization criteria for the credit payment device, the purchase authorization criteria setting forth conditions for authorizing credit transactions made using the credit payment device; associate the set of purchase authorization criteria with the credit payment device; receive a request for authorization of a proposed credit transaction made using the credit payment device; and determine whether the proposed credit transaction complies with the set of purchase authorization criteria.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system diagram according to an embodiment of the present invention.

FIG. 3 depicts a method flow diagram according to an embodiment of the present invention.

FIG. 4 depicts another method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As mentioned above, embodiments of the present invention provide an approach for credit transaction authorization/approval. Specifically, in a typical embodiment, a particular transaction payment device/mechanism (e.g., credit card, etc.) may be associated with a set of purchase authorization criteria/rules that sets forth specific conditions under which the transaction payment device may be utilized. Along these lines, the set of purchase authorization criteria typically comprises an authorization protocol that may be generated in multiple ways. For example, the authorization protocol may be generated: manually based on a set of predetermined authorized expenses; automatically based on at least one of the following: a set of calendar entries, a set of geographic location-based services, or a social networking check-in service; and/or automatically based upon historical purchase data stored in at least one computer storage device. When a user later attempts to conduct a proposed credit transaction using the transaction payment device, it will be determined whether the proposed credit transaction complies with this set of purchase authorization criteria (e.g., the authorization protocol). Based on this determination, the proposed credit transaction can be approved or declined.

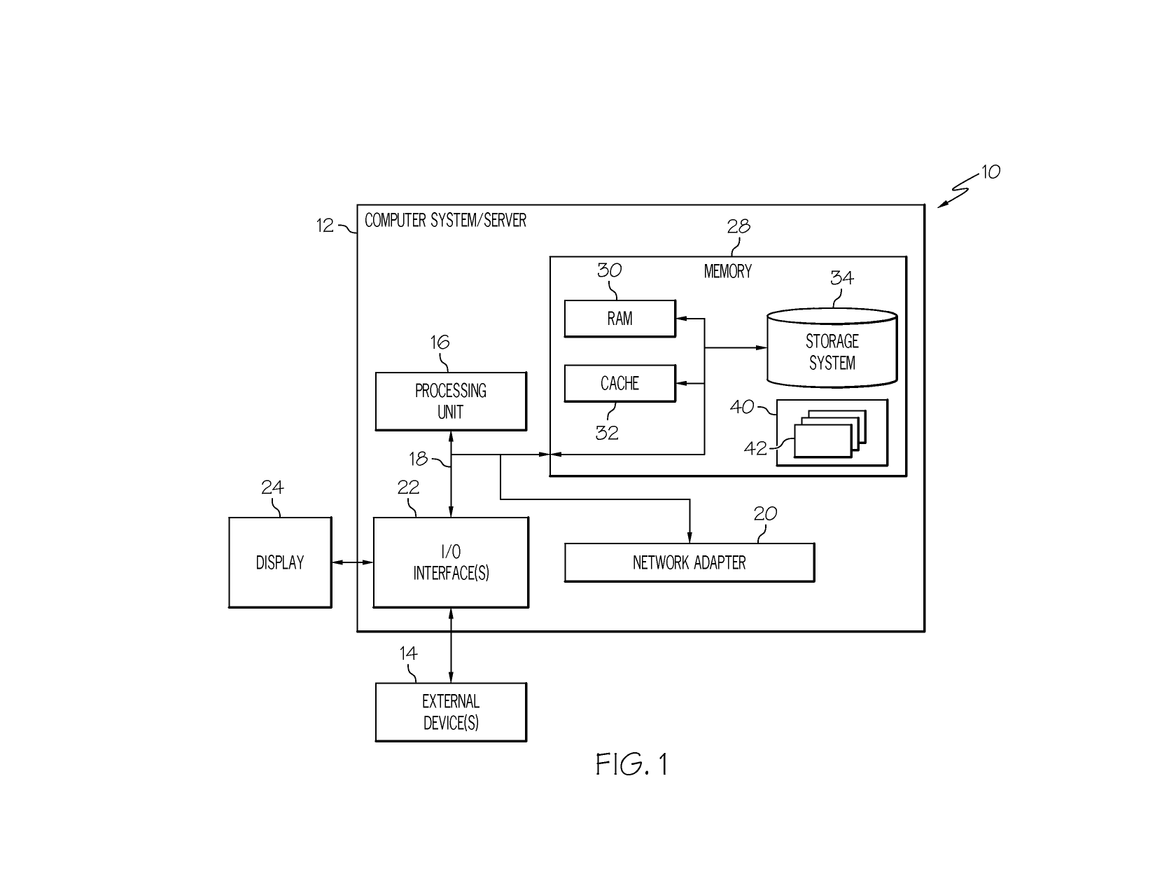

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, mobile devices, global positioning systems (GPS), GPS -enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Transaction authorization program/utility 40, having a set (at least one) of program modules 42, may be stored in memory 28 by way of example, and not limitation, as well as an operating system, one or more application programs, other program modules, and program data. In general, transaction authorization program 40 performs the function of the present invention as described herein. For example, transaction authorization program 40 will: receive a prescription related to a medical condition of a patient in a computer memory medium (e.g., comprising a set of criteria for a desired travel route for the patient); receive information corresponding to a geographical area associated with the patient; identify a set of possible travel routes between a starting point and a destination within the geographical area based on the information; determine at least one travel route from the possible travel routes for treating the medical condition based on a comparison of the set of criteria to the information; and/or recommend the at least one travel route to the patient. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

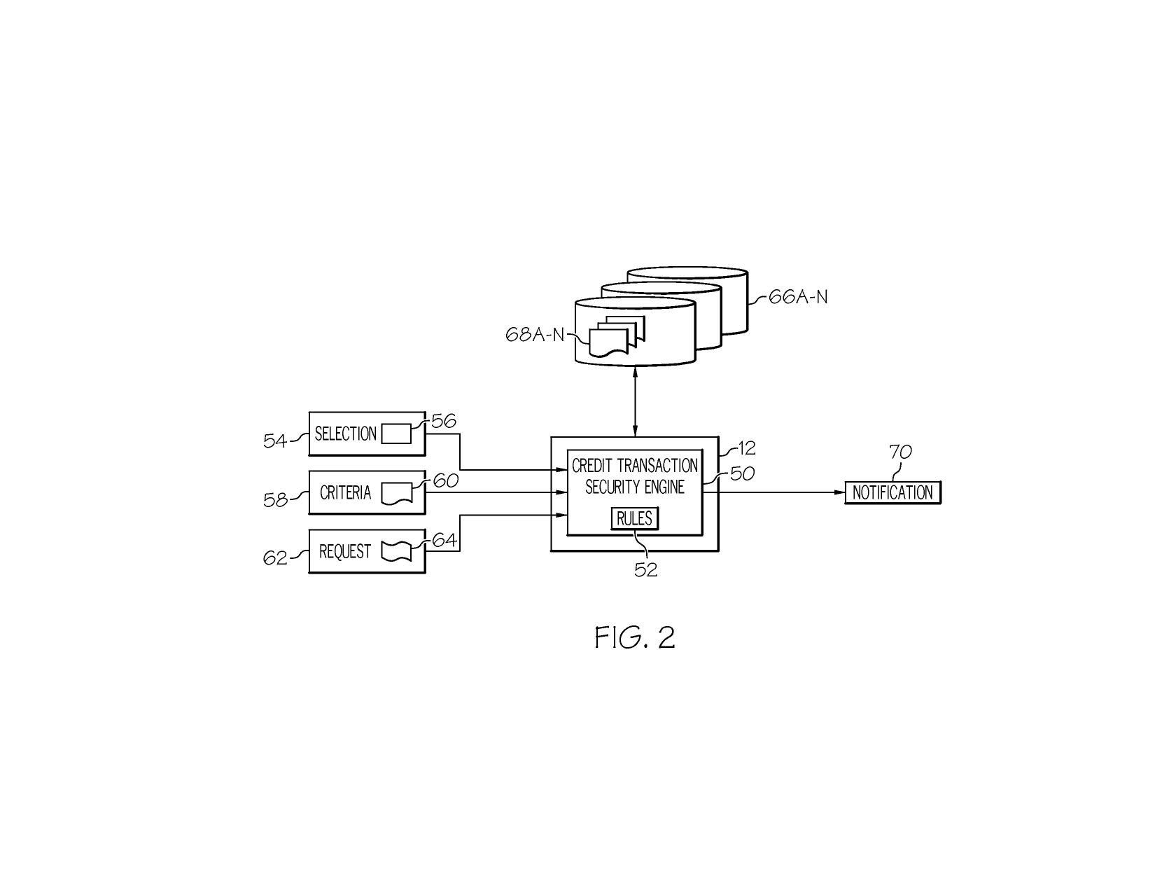

Referring now to FIG. 2, a system diagram describing the functionality discussed herein according to an embodiment of the present invention is shown. It is understood that the teachings recited herein may be practiced within any type of networked computing environment (e.g., a cloud computing environment). A stand-alone computer system/server 12 is shown in FIG. 1 for simplicity purposes only. In the event the teachings recited herein are practiced in a networked computing environment, each client need not have a transaction authorization engine (engine 50). Rather, engine 50 could be loaded on a server (e.g., payment processing server) or server-capable device that communicates (e.g., wirelessly) with the clients to provide credit transaction authorization functionality hereunder. Regardless, as depicted, engine 50 is shown within computer system/server 12. In general, engine 50 can be implemented as program/utility 40 on computer system 12 of FIG. 1 and can enable the functions recited herein. As further shown, engine 50 (in one embodiment) comprises a rules and/or computational engine that processes a set (at least one) of rules/logic 52 and/or provides credit transaction authorization functionality hereunder.

Along these lines, engine 50 may perform multiple functions similar to a general-purpose computer. Specifically, among other functions, engine 50 may (among other things): receive a selection 54 of a credit payment device 56 (e.g., credit card, radio-frequency identification (RFID)-base device, etc.) in a computer memory medium (e.g., memory 28 of FIG. 1); receive a set of purchase authorization criteria 58 (e.g., a financial/purchasing plan 60 setting forth conditions for approving credit transactions made using the credit payment device 56) for the credit payment device 56; associate the set of purchase authorization criteria 58 with the credit payment device 56; receive a request 62 for approval of a proposed credit transaction 64 made using the credit payment device 56; determine whether the proposed credit transaction 64 complies with the set of purchase authorization criteria 58; responsive to the proposed credit transaction 64 complying with the set of purchase authorization criteria 58, approve the proposed credit transaction 64; responsive to the proposed credit transaction 64 failing to comply with the set of purchase authorization criteria 58, reject the proposed credit transaction 64; manually generate the authorization protocol 60 based on a set of predetermined authorized expenses; automatically generate the authorization protocol 60 on at least one of the following: a set of calendar entries, a set of geographic location-based services, or a social networking check-in service; automatically generate the authorization protocol 60 based upon historical purchase data 68A-N stored in at least one computer storage device 66A-N; and/or send a notification 70 based on the determination.

As indicated above, embodiments of the present invention involve the association of a credit payment device 56 with purchase authorization criteria 58. As further indicated, purchase authorization criteria 58 may comprise one or more authorization protocols 60 (e.g., financial/purchasing plans) setting forth the conditions under which proposed credit transactions may be approved. Below are multiple ways in which an authorization protocol 60 may be generated. It is understood that these methods are not intended to be mutually exclusive. Rather, purchase authorization criteria comprise one or more plans generated in accordance with any of these methods or combinations thereof. It is further understood that the methods set forth below are not intended to be limiting and that other alternatives may exist

Manual Authorization Protocol Programming: This method allows an individual to program a credit or debit card authorization service to only accept specific charges or charges based on a pre-determined authorization protocol. The authorization protocol may include spending limits on categories and areas within specific dates. For example, as part of trip planning, a user may allocate specific amounts to expense categories during a specified duration. The user may specify that up to $500 may be spent at a hotel in a region, $150 for gasoline in one or more states, $300 for food in a specific region, etc. Any purchases outside of those specified will be rejected, and the purchasing rejection or rejection notification method be invoked. Such programming can be accomplished using a “thick” or “thin” client and a secure connection to the authorization service. In it, a user may specify the dates of travel along with the locations. For example, a given user may be scheduled to fly from Charlottesville, Va., to Washington, D.C., then on to Denver, Colo., for a three-day trip. Prior to the trip, the user would enter planned locations and dates, along with the desired spending limits. In the event of travel disruption (e.g., a rerouted flight), the user would use a secure connection to change or disable the protection limits.

Automatic Authorization Protocol Programming: This method automatically programs a device based on calendar entries, location-based services, and/or social networking “check-in” services. The automatic plan programming may be linked to a user's calendar. Calendar entries typically include a location field. This method would leverage that location field and only allow purchases within a predetermined (or user defined) range of the specified location. For example, a user's calendar may indicate the user will be in Dallas during a specified day. In this method, only purchases that occurred within the city limits of Dallas (or within X miles of Dallas) would be approved. The method may be used in conjunction with the manual plan to specify spending limits by category. Furthermore, as mentioned above, this embodiment may leverage location based social networking “check-in” services. In this case, financial authorization may be automatically augmented if a user checks into a venue using such available technologies.

Automatic Recurring Purchase Exemptions: This method analyzes previous spending history (68A-N) after a manual or automatic authorization protocol is generated. The history is checked for recurring purchases. For example, a user may have a setup in which her credit card is billed monthly for her mobile phone usage. If history indicates this may happen during the time period specified for the manual or automatic authorization protocol, these transactions may optionally be automatically approved even though they are not specified in the authorization protocol. In another example, a consultant may routinely travel to a given location (e.g., flying from Austin to Abilene, Tex. each Monday through Thursday). In this case, the authorization service would recognize these recurring needs and set up authorizations accordingly.

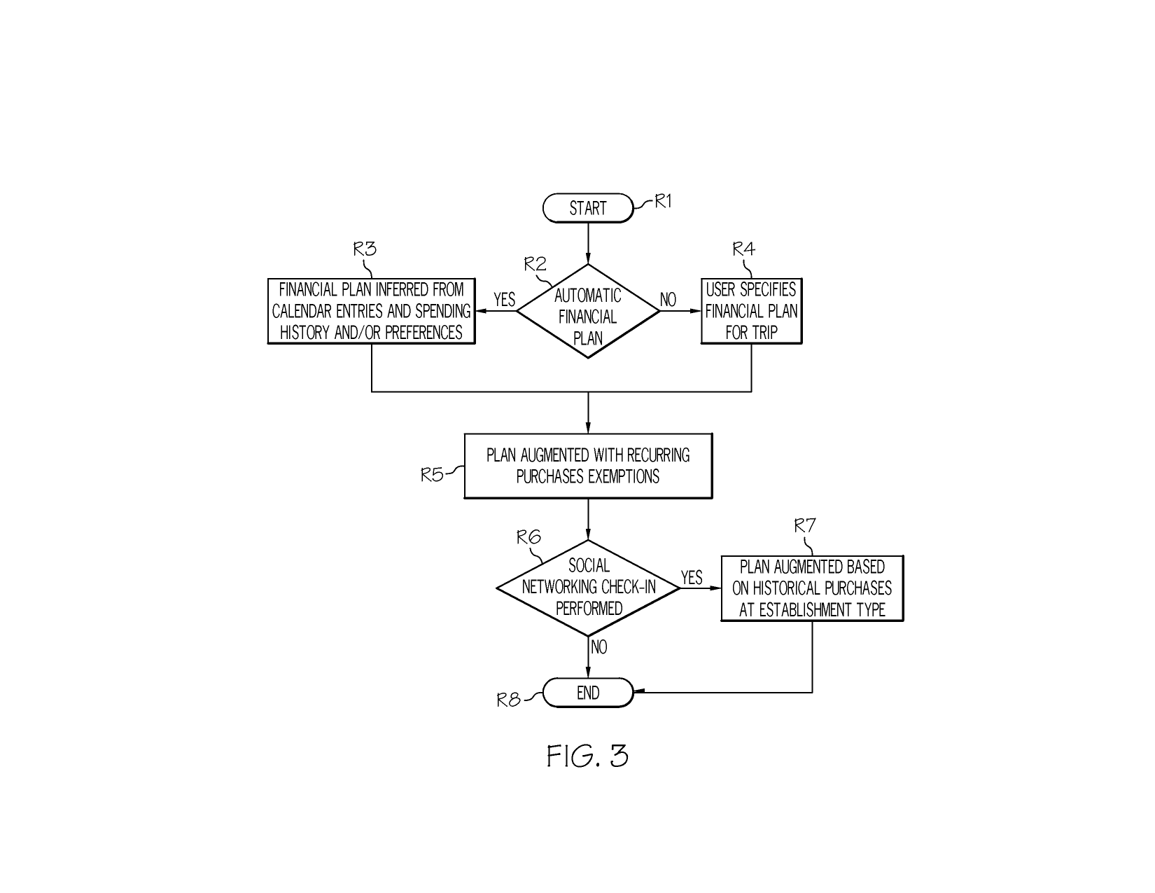

Referring now to FIG. 3, a method flow diagram illustrating the authorization protocol aspects of the present invention is shown. As depicted, the process is started in step R1. In step R2, it is determined whether an automatic authorization protocol is desired by a user for association with a credit payment device. If so, the authorization protocol may be inferred from calendar entries, spending history, preferences, etc., in step R3. If not, a user may manually specify an authorization protocol in step R4. In step R5, the authorization protocol may be augmented with recurring purchase exemptions. In step R6, it is determined whether the user has performed a social networking check-in. If so, the authorization protocol may be further augmented based on historical purchases according to establishment type (e.g., in comparison to the user's check-in) in step R7. If not, the authorization protocol may be deemed complete and the process may end in step R8.

Purchasing Rejection: This method enables a user to prevent the rejection of pending authorizations if they use a smart phone. When an authorization is initiated by a merchant that is outside of the specified authorization protocol, a message may be sent to an application running on the user's smart phone. The smart phone will notify the user of the incoming message and display the merchant, amount and location. The user may then authorize the purchase, optionally being required to specify a code to authorize.

Rejection Notification: This method may be used instead of, or in conjunction with, the purchasing rejection method. This method notifies the owner of the card via one of many notification methods such as e-mail, SMS, or automated phone call, that a purchase has been rejected based on deviation from a manually or automatically generated authorization protocol. The user may then initiate contact with the credit company to receive details about the rejected purchase and/or initiate fraud reporting.

Additional Embodiments: It should be noted that embodiments of the proposed invention may vary. For example, the invention may apply to a user's primary card or a separate card tied to the primary card, such that the primary card does not have these restrictions. Such an embodiment would enable the individual to leave the primary card safely at home and only bring the pre-authorized card on a trip.

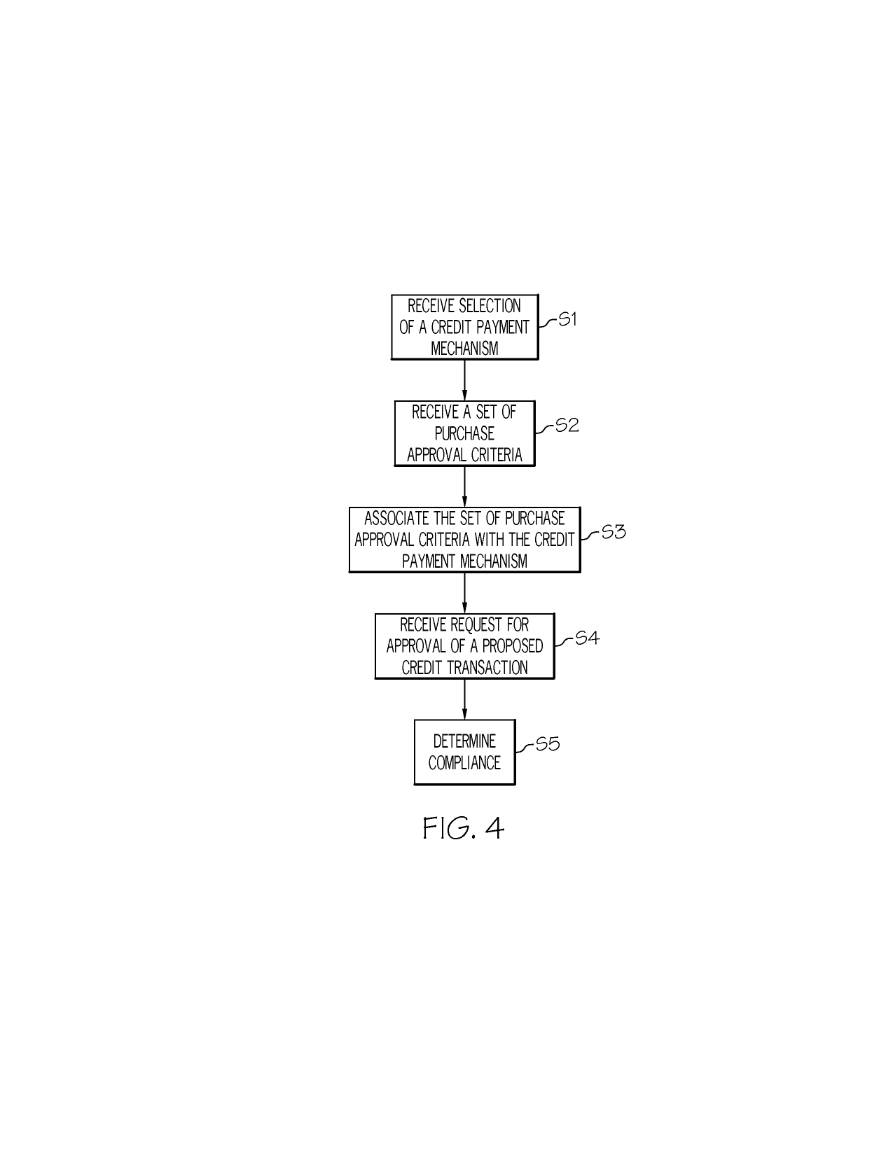

Referring now to FIG. 4, a method flow diagram according to an embodiment of the present invention is shown (e.g., as enabled by engine 50 of FIG. 2). As depicted, in step S1, a selection of a credit payment device is received in a computer memory medium. In step S2, a set of purchase authorization criteria is received for the credit payment device. In step S3, the set of purchase authorization criteria is associated with the credit payment device. In step S4, a request for authorization of a proposed credit transaction made using the credit payment device is received. In step S5, it is determined whether the proposed credit transaction complies with the set of purchase authorization criteria.

While shown and described herein as a transaction authorization solution, it is understood that the invention further provides various alternative embodiments. For example, in one embodiment, the invention provides a computer-readable/useable medium that includes computer program code to enable a computer infrastructure to provide transaction authorization functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide transaction authorization functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for transaction authorization. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A computer-implemented method for authorizing credit transactions, comprising:
receiving, using at least one computing device, a selection of a credit payment device in a computer memory medium;
receiving, using the at least one computing device, a set of purchase authorization criteria for the credit payment device, the purchase authorization criteria setting forth an authorization protocol for authorizing credit transactions made using the credit payment device, the authorization protocol requiring that a location of a proposed credit transaction be within a predetermined range of a specified location extracted from a set of calendar entries, a set of geographic location-based services, or a social networking check-in service unless a historical analysis indicates the proposed credit transaction may occur during a time period specified for the authorization protocol;
associating, using the at least one computing device, the set of purchase authorization criteria with the credit payment device;
receiving, using the at least one computing device, a request for approval of a proposed credit transaction made using the credit payment device; and
determining, using the at least one computing device, whether the proposed credit transaction complies with the set of purchase authorization criteria.

2. The computer-implemented method of claim 1, further comprising, responsive to the proposed credit transaction complying with the set of purchase authorization criteria, using the at least one computing device, with the set of purchase authorization criteria, authorizing the proposed credit transaction.

3. The computer-implemented method of claim 1, further comprising, responsive to the proposed credit transaction failing to comply with the set of purchase authorization criteria, rejecting, using the at least one computing device, the proposed credit transaction.

4. (canceled)

5. The computer-implemented method of claim 1, the authorization protocol being manually generated.

6. The computer-implemented method of claim 1, the authorization protocol being automatically generated based on at least one of the following: the set of calendar entries, the set of geographic location-based services, and the social networking check-in service.

7. The computer-implemented method of claim 1, the authorization protocol being automatically generated.

8. The computer-implemented method of claim 1, further comprising sending, using the at least one computing device, a notification based on the determining.

9. A system for authorizing credit transactions, comprising:
a memory medium comprising instructions;
a bus coupled to the memory medium; and
a processor coupled to the bus that when executing the instructions causes the system to:
receive a selection of a credit payment device in a computer memory medium;
receive a set of purchase authorization criteria for the credit payment device, the purchase authorization criteria setting forth an authorization protocol for authorizing credit transactions made using the credit payment device, the authorization protocol requiring that a location of a proposed credit transaction be within a predetermined range of a specified location extracted from a set of calendar entries, a set of geographic location-based services, or a social networking check-in service;
associate the set of purchase authorization criteria with the credit payment device;
receive a request for approval of a proposed credit transaction made using the credit payment device;
determine whether the proposed credit transaction complies with the set of purchase authorization criteria; and
responsive to the proposed credit transaction failing to comply with the set of purchase authorization criteria, authorize the proposed credit transaction where a historical analysis indicates the proposed credit transaction may occur during a time period specified for the authorization protocol.

10. The system of claim 9, the memory medium further comprising instructions for causing the system to, responsive to the proposed credit transaction complying with the set of purchase authorization criteria, authorize the proposed credit transaction.

11. The system of claim 9, the memory medium further comprising instructions for causing the system to, responsive to the proposed credit transaction failing to comply with the set of purchase authorization criteria, reject the proposed credit transaction.

12. (canceled)

13. The system of claim 8, the authorization protocol being manually generated.

14. The system of claim 8, the authorization protocol being automatically generated being based on at least one of the following: the set of calendar entries, the set of geographic location-based services, and the social networking check-in service.

15. The system of claim 8, the authorization protocol being automatically generated based upon historical purchase data stored in at lust one computer storage device.

16. The system of claim 9, the memory medium further comprising instructions for causing the system to send a notification based on the determination.

17. A computer program product for authorizing credit transactions, the computer program product comprising a computer readable storage media, and program instructions stored on the computer readable storage media, to:
receive a selection of a credit payment device in a computer memory medium;
receive a set of purchase authorization criteria for the credit payment device, the purchase authorization criteria setting forth an authorization protocol for authorizing credit transactions made using the credit payment device, the authorization protocol requiring that a location of a proposed credit transaction be within a predetermined range of a specified location extracted from a set of calendar entries, a set of geographic location-based services, or a social networking check-in service, except where an exception applies, the exception comprising a historical analysis indicating the proposed credit transaction may occur during a time period specified for the authorization protocol;
associate the set of purchase authorization criteria with the credit payment device;
receive a request for approval of a proposed credit transaction made using the credit payment device; and
determine whether the proposed credit transaction complies with the set of purchase authorization criteria.

18. The computer program product of claim 17, the computer readable storage media further comprising instructions to, responsive to the proposed credit transaction complying with the set of purchase authorization criteria, authorize the proposed credit transaction.

19. The computer program product of claim 17, the computer readable storage media further comprising instructions to, responsive to the proposed credit transaction failing to comply with the set of purchase authorization criteria, reject the proposed credit transaction.

20. (canceled)

21. The computer program product of claim 17, the authorization protocol being manually generated and comprising a set of predetermined authorized expenses.

22. The computer program product of claim 17, the authorization protocol being automatically generated being based on at lust one of the following: the set of calendar entries, the set of geographic location-based services, and the social networking check-in service.

23. The computer program product of claim 17, the authorization protocol being automatically generated.

24. The computer program product of claim 17, the computer readable storage media further comprising instructions to send a notification based on the determination.

25. A method for deploying a system for authorizing credit transactions, comprising:
receive, via a computer infrastructure, a selection of a credit payment device in a computer memory medium;
receive, via the computer infrastructure, a set of purchase authorization criteria for the credit payment device, the purchase authorization criteria setting forth an authorization protocol for authorizing credit transactions made using the credit payment device, the authorization protocol requiring that a location of a proposed credit transaction be within a predetermined range of a specified location extracted from an entry within a user's calendar;
associate, via the computer infrastructure, the set of purchase authorization criteria with the credit payment device;
receive, via the computer infrastructure, a request for approval of a proposed credit transaction made using the credit payment device; and
determine, via the computer infrastructure, whether the proposed credit transaction complies with the set of purchase authorization criteria;
wherein the computer infrastructure comprises at least one computer.

26. The computer program product of claim 1, further comprising authorizing the proposed credit transaction where the historical analysis indicates the proposed credit transaction may occur during the time period specified for the authorization protocol.

27. The computer program product of claim 17, the computer readable storage media further comprising instructions to, responsive to the exception applying, authorize the proposed credit transaction.

28. The computer-implemented method of claim 25, further comprising, responsive to the proposed credit transaction failing to comply with the purchase authorization criteria, authorizing, via the computer infrastructure, the proposed credit transaction where the historical analysis indicates the proposed credit transaction may occur during the time period specified for the authorization protocol.
